(19) United States
(12) Patent Application Publication
(10) Pub. No.: US 2008/0302942 A1
(43) Pub. Date: Dec. 11, 2008

(54) Roller support bracket for sawhorse

(76) Inventors: David M. Thompson, Bricktown, NJ (US); Steven J. Mayhew, Bricktown, NJ (US)

Correspondence Address: ANDREW W. LUDY, 17 SHERWOOD WAY, P.O. Box 418, Mt. Arlington, NJ, 07856, US

(21) Appl. No.: 11/810,589

(22) Filed: Jun. 6, 2007

(51) Int. Cl. F16L 3/02

(52) U.S. Cl. 248/535

(57) ABSTRACT

A pair of roller support brackets is used with a roller and legs to form a combination sawhorse and roller support. The tubular roller and tubular legs are circular sections of PVC pipe. Each PVC bracket has a longitudinal circular socket with a bore through it to slidingly receive the roller. First and second leg sockets extend downward and transversely outward from the longitudinal socket outer surface. The circular leg sockets each have a blind bore to receive the legs. A platform extends transversely outward from atop the longitudinal socket on either side. The platform has slots extending through it at the ends. The platform supports an optional flat beam, typically a 2×4 bolted on. The flat beam provides a conventional style sawhorse for cutting directly upon.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to the field of sawhorses, and more particularly to a pair of brackets used to clamp four legs and a crossbeam together to form a sawhorse.

Carpenters, plumbers, siding installers, and other tradesmen often have need for a sawhorse in the field. The sawhorse should be configured to be quickly set up for use, and quickly broken down for storage. The sawhorse should be constructed of readily available materials that are strong, corrosion and rot resistant, and lightweight.

A circular saw set up in the field or in the shop requires a roller support behind the saw to aid in cutting a long piece of material, so that the work piece does not sag downward by it's weight. A sawhorse that can accomplish both tasks would be ideal. For versatility, it should be possible to fasten a wood beam across the brackets for a more conventional sawhorse.

Sawhorse brackets are known and have taken a variety of configurations in the past. Some examples of sawhorses in the prior art are as follows:

Breisch, U.S. Pat. No. 4,457,399; shows a pair of brackets 14, each having two circular sockets 29 extending downward and outward for legs 13, and a circular socket 28 extending longitudinally for a fixed beam 12, and two semicircular sockets for longitudinal cambered beams 11. The fixed beam 12 is held tightly by friction in the socket 28, and thus cannot rotate. The upper cambered beams 11 cannot serve as rollers because of their irregular shape. The fixed beam 12 cannot serve as a roller because it is held tightly by being wedged into the tapered socket 28. Breisch 399 therefore cannot be used as a roller support for lumber being sawn. Breisch 399 includes a wood beam 42 that is not secured to the bracket 14 with threaded fasteners, but is wedged with blocks 43.

Bradley, U.S. Pat. No. 488,349; and Neeley, U.S. Pat. No. 3,175,642; each illustrate a pair of sawhorse brackets, each bracket having two circular sockets extending downward and outward for legs, and a circular socket extending longitudinally for a fixed beam. In each case, the fixed beam is held tightly in the socket by a setscrew, and cannot rotate. Even with the setscrew loosened, the steel tube beams would not rotate freely inside the steel bracket sockets because of friction. Neither sawhorse can double as a roller support.

Accordingly, there is a need to provide a sawhorse bracket that can be quickly set up for use, and quickly broken down for storage.

There is a further need to provide a sawhorse bracket of the type described and that is constructed of readily available materials that are strong, corrosion and rot resistant, and lightweight.

There is a yet further need to provide a sawhorse bracket of the type described and that is made of low friction materials to allow a circular beam to rotate freely, so that a pair of brackets can double as a roller support for circular saw work.

There is a still further need to provide a sawhorse bracket of the type described and that will accommodate a wood beam fastened securely across the pair of brackets for a more conventional sawhorse.

There is another need to provide a sawhorse bracket of the type described and that can be manufactured cost-effectively in large quantities of high quality.

### BRIEF SUMMARY OF THE INVENTION

In accordance with the present invention, there is provided a roller support bracket for a sawhorse. A pair of the brackets is used in connection with a longitudinal tubular roller and four upright tubular legs. The tubular roller and tubular legs are circular cylinders, typically sections of PVC pipe.

The roller support bracket comprises a longitudinal socket with opposite first and second ends. The longitudinal socket is a cylinder of circular cross section. The longitudinal socket has a bore through it extending along the longitudinal axis. The longitudinal socket has an outer and an inner surface. The longitudinal socket is adapted to slidingly receive the tubular roller.

First and second leg sockets extend downward and transversely outward from a proximal end at the longitudinal socket outer surface to a distal end. The first and second leg sockets are on opposite sides of a longitudinal vertical plane. The first and second leg sockets are cylinders of circular cross section. The first and second leg sockets each have a blind bore extending from the distal end toward the proximal end. Lines representing the bores of the first and second leg sockets, when projected upward, will appear to pass through the longitudinal socket bore. The upward forces of the legs are thus transmitted in line to the longitudinal socket. The first and second leg sockets each have an outer and an inner surface. The first and second leg sockets are adapted to slidingly receive the legs.

A platform extends transversely outward from atop the longitudinal socket on either side of the longitudinal vertical plane. The platform extends between opposite first and second ends. The platform has an upper surface and a lower surface. The platform has a first and a second aperture extending through from the upper surface to the lower surface at the first and second ends respectively. The first and second apertures each typically comprise a slot extending transversely inward from the platform first and second end respectively. The platform supports an optional flat beam, typically a construction grade 2×4 or 2×6, fastened with bolts and nuts. The flat beam provides a conventional style sawhorse for cutting directly upon.

The roller support bracket is molded from a polymeric resin selected from the group consisting of thermoset resins and thermoplastic resins. The preferred material is PVC resin, to match the tubular roller and tubular legs. However, any structural grade resin will serve, such as nylon or ABS.

### BRIEF DESCRIPTION OF THE SEVERAL VIEWS OF THE DRAWING

A more complete understanding of the present invention may be obtained from consideration of the following description in conjunction with the drawing, in which:

FIG. 1 is an exploded assembly perspective view of a pair of roller support brackets for a sawhorse constructed in accordance with the invention, showing installation with a longitudinal tubular roller and a plurality of upright tubular legs.

FIG. 2 is a collapsed perspective view of the assembly of FIG. 1.

FIG. 3 is an exploded assembly perspective view of the pair of roller support brackets of FIG. 1, showing installation with a flat beam and a plurality of upright tubular legs.

FIG. 4 is a collapsed perspective view of the assembly of FIG. 3.

FIG. 5 is a perspective view of the roller support bracket of FIG. 1, showing hidden lines.

FIG. 6 is a front elevational view of the roller support bracket of FIG. 1.

FIG. 7 is a right side elevational view of the roller support bracket of FIG. 1.

FIG. 8 is a top view of the roller support bracket of FIG. 1.

FIG. 9 is a bottom view of the roller support bracket of FIG. 1, projected from the right leg socket.

FIG. 10 is an exploded assembly perspective view of another pair of roller support brackets for a sawhorse constructed in accordance with the invention, showing installation with a longitudinal tubular roller and a plurality of upright tubular legs.

FIG. 11 is a collapsed perspective view of the assembly of FIG. 10.

FIG. 12 is an exploded assembly perspective view of the pair of roller support brackets of FIG. 10, showing installation with a flat beam and a plurality of upright tubular legs.

FIG. 13 is a collapsed perspective view of the assembly of FIG. 12.

FIG. 14 is a perspective view of the roller support bracket of FIG. 10, showing hidden lines.

FIG. 15 is a front elevational view of the roller support bracket of FIG. 10.

FIG. 16 is a right side elevational view of the roller support bracket of FIG. 10.

FIG. 17 is a top view of the roller support bracket of FIG. 10.

FIG. 18 is a bottom view of the roller support bracket of FIG. 10.

### DETAILED DESCRIPTION OF THE INVENTION

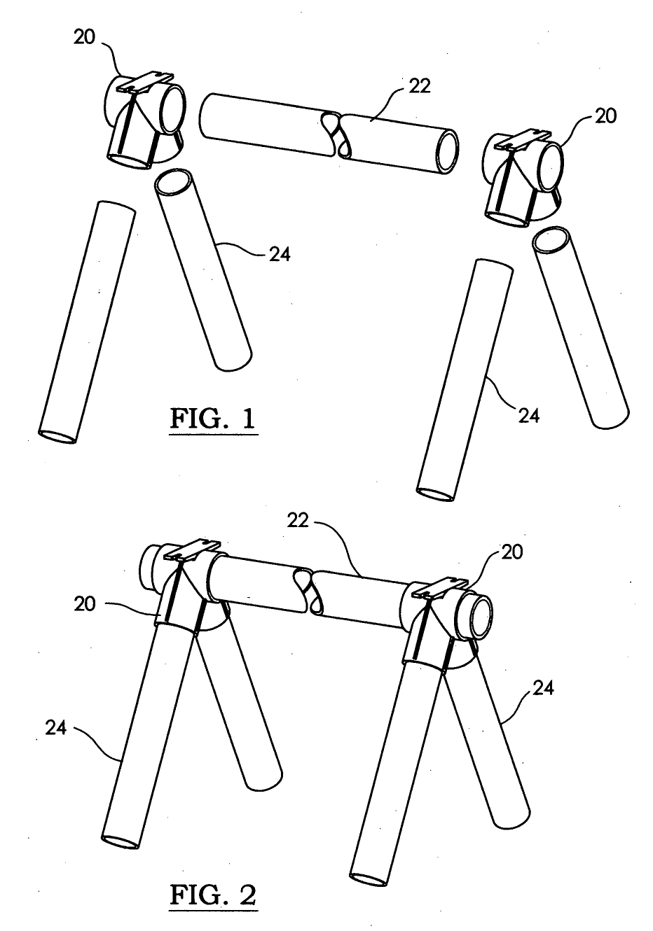

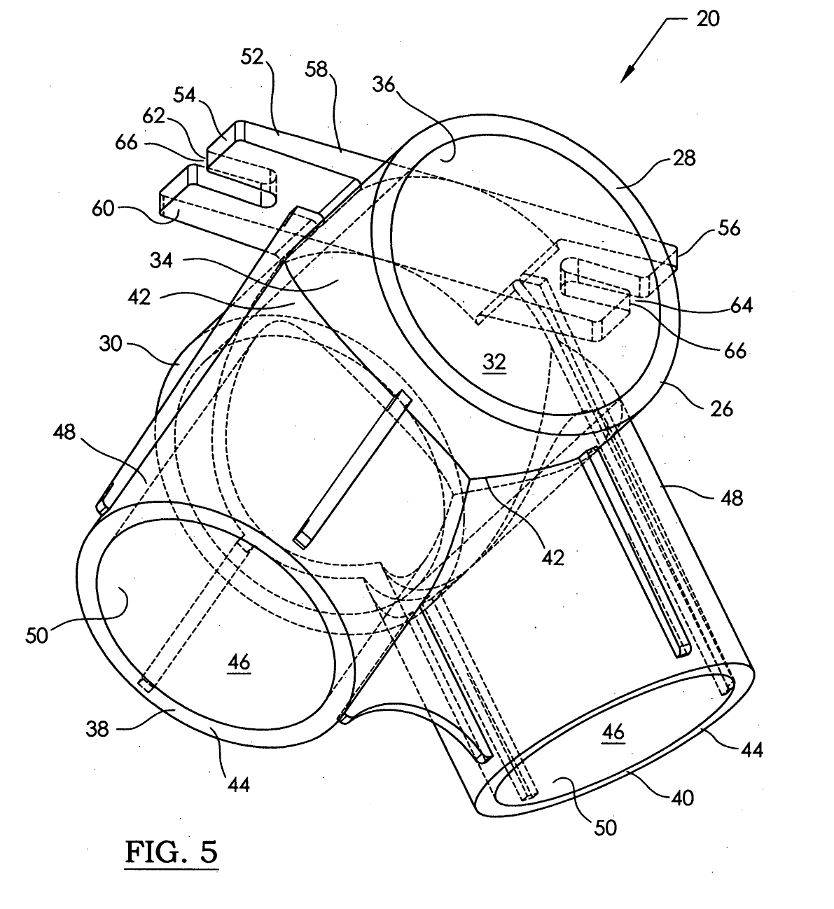

Referring now to the drawing, and especially to FIGS. 1-9 thereof, a roller support bracket for a sawhorse is shown at 20. A pair of support brackets 20 is used in connection with a longitudinal tubular roller 22 and a plurality of upright tubular legs 24, specifically four legs, and two legs per bracket. The tubular roller 22 and tubular legs 24 are circular cylinders, and typically will be sections of PVC pipe that can be bought in any supply store and cut to an appropriate length.

The roller support bracket 20 comprises a longitudinal socket 26 extending along a longitudinal axis between opposite first 28 and second 30 ends. The longitudinal socket 26 is a cylinder of circular cross section. The longitudinal socket 26 has a bore 32 completely through it extending along the longitudinal axis. The longitudinal socket 26 has an outer surface 34 and an inner surface 36. The longitudinal socket 26 is adapted to slidingly receive the tubular roller 22.

First 38 and second 40 leg sockets extend downward and transversely outward from a proximal end 42 at the longitudinal socket outer surface 34 to a distal end 44. The first 38 and second 40 leg sockets are on opposite sides of a longitudinal vertical plane. The first 38 and second 40 leg sockets are cylinders of circular cross section. The first 38 and second 40 leg sockets each have a blind bore 46 extending from the distal end 44 toward the proximal end 42. If the lines representing the bores of the first and second leg sockets are projected upward, they will pass through the longitudinal socket bore. The upward forces of the legs are thus transmitted in line to the longitudinal socket, with no induced moment, for maximum strength. The first 38 and second 40 leg sockets each have an outer surface 48 and an inner surface 50. The first 38 and second 40 leg sockets are adapted to slidingly receive the legs 24.

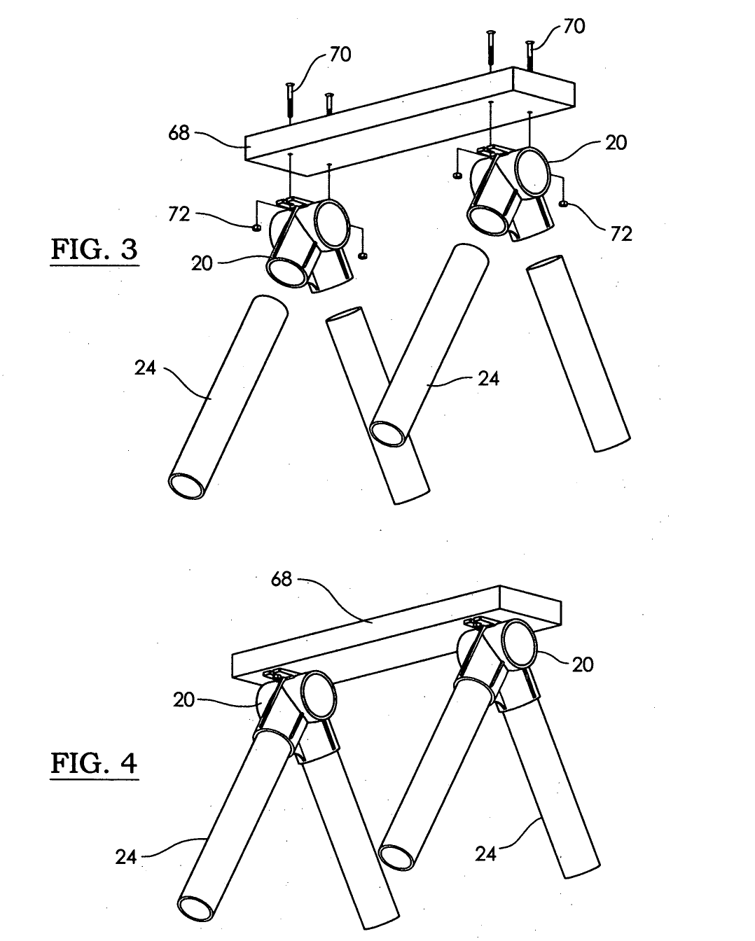

A platform 52 extends transversely outward from atop the longitudinal socket 26 on either side of the longitudinal vertical plane. The platform 52 extends between opposite first 54 and second 56 ends. The platform 52 has an upper surface 58 and a lower surface 60. The platform 52 has a first 62 and a second 64 aperture extending through from the upper surface 58 to the lower surface 60 at the first 54 and second 56 ends respectively. The first 62 and second 64 apertures each typically comprise a slot 66 extending transversely inward from the platform first 54 and second end 56 respectively. The platform 52 serves to support an optional flat beam 68, as shown in FIGS. 3 and 4. The flat beam 68 is typically a construction grade 2×4 or 2×6 and is fastened through the slot 66 with bolts 70 and nuts 72. Wood screws (not shown) can be used. The flat beam 68 provides a conventional style sawhorse for cutting directly upon.

The roller support bracket 20 is molded from a polymeric resin selected from the group consisting of thermoset resins and thermoplastic resins. The preferred material is PVC resin, to match the tubular roller 22 and tubular legs 24. However, any structural grade resin will serve, such as nylon or ABS.

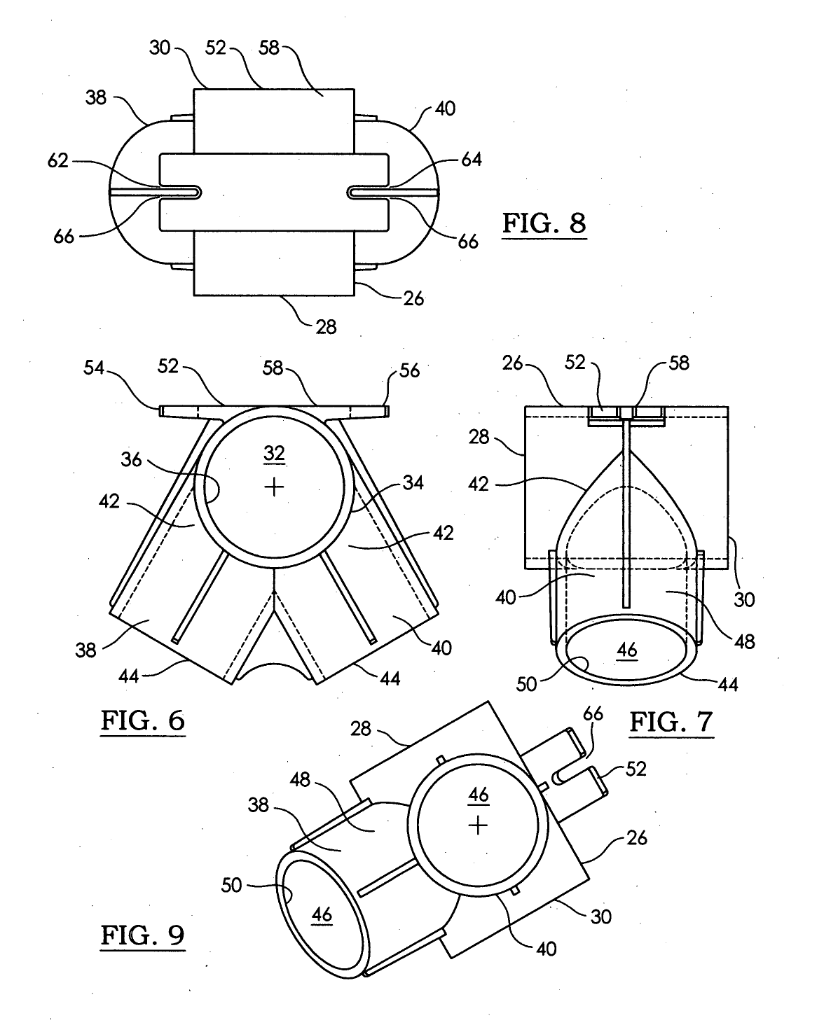

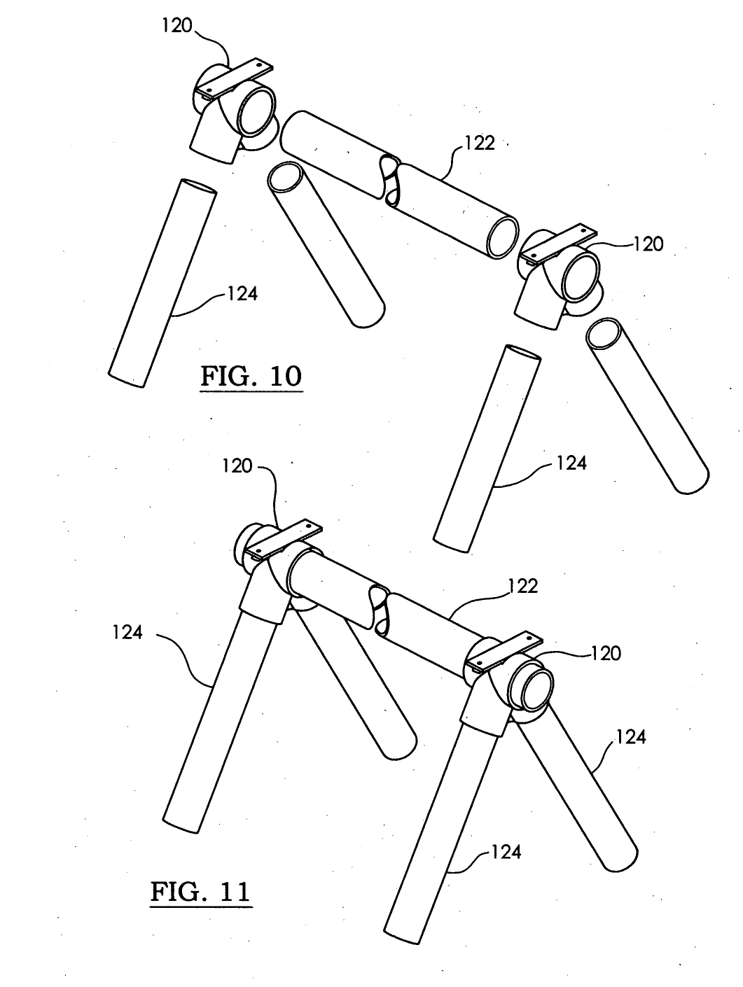

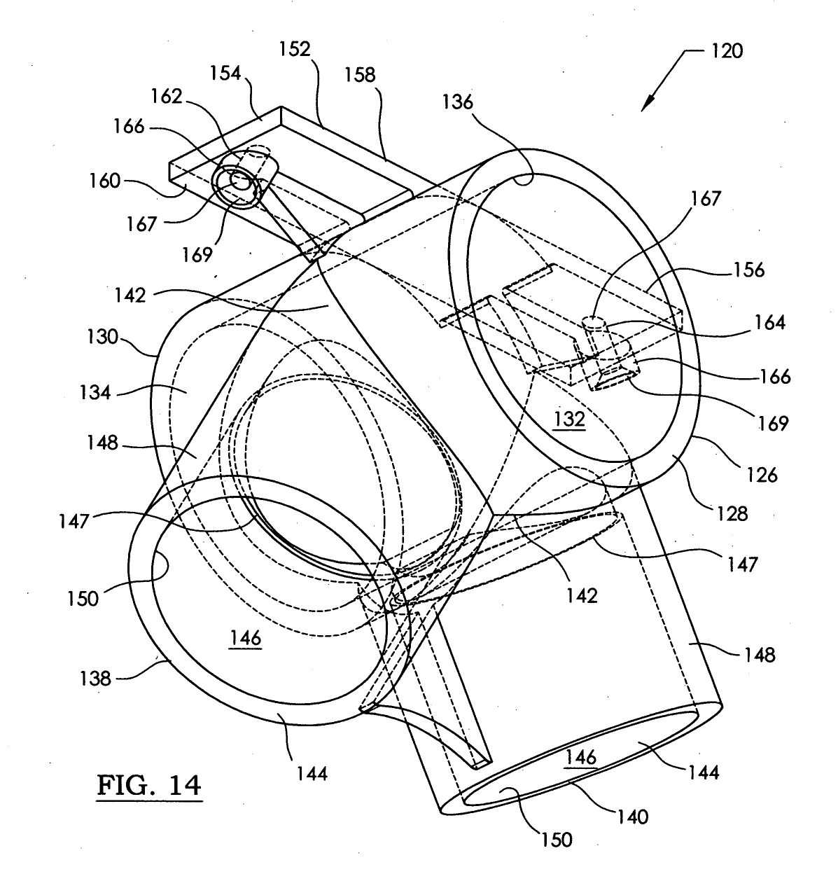

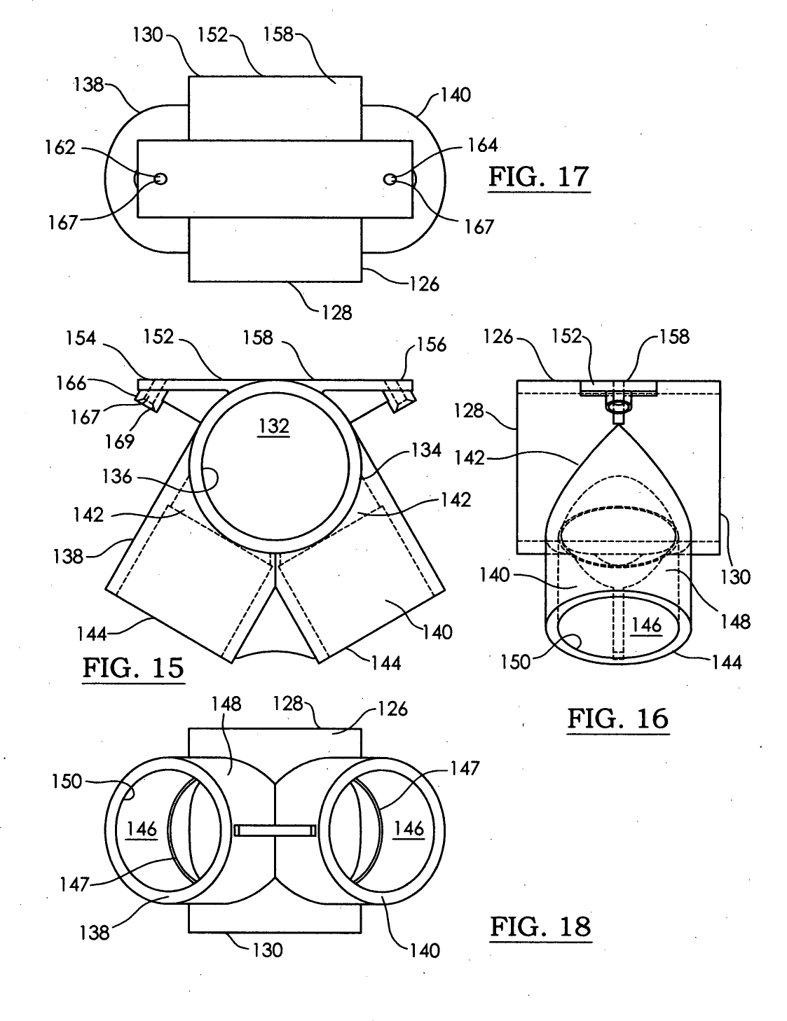

Turning now to FIGS. 6-18, another roller support bracket for a sawhorse is shown at 120, and is for use in connection with a longitudinal tubular roller 122 and a plurality of upright tubular legs 124. Roller support bracket 120 is similar to roller support bracket 20 described above, in that the tubular roller 122 and tubular legs 124 are circular cylinders, and typically will be sections of PVC pipe.

The roller support bracket 120 comprises a longitudinal socket 126 extending along a longitudinal axis between opposite first 128 and second 130 ends. The longitudinal socket 126 is a cylinder of circular cross section. The longitudinal socket 126 has a bore 132 completely through it extending along the longitudinal axis. The longitudinal socket 126 has an outer surface 134 and an inner surface 136. The longitudinal socket 126 is adapted to slidingly receive the tubular roller 122.

First 138 and second 140 leg sockets extend downward and transversely outward from a proximal end 142 at the longitudinal socket outer surface 134 to a distal end 144. The first 138 and second 140 leg sockets are on opposite sides of a longitudinal vertical plane. The first 138 and second 140 leg sockets are cylinders of circular cross section. The first 138 and second 140 leg sockets each have a blind bore 146 extending from the distal end 144 toward the proximal end 142. The bore 146 has a shoulder 147 adjacent the proximal end 142 to provide bearing for the legs. If the lines representing the bores of the first and second leg sockets are projected upward, they will pass through the longitudinal socket bore. The upward forces of the legs are thus transmitted in line to the longitudinal socket, with no induced moment, for maximum strength. The first 138 and second 140 leg sockets each have an outer surface 148 and an inner surface 150. The first 138 and second 140 leg sockets are adapted to slidingly receive the legs 124.

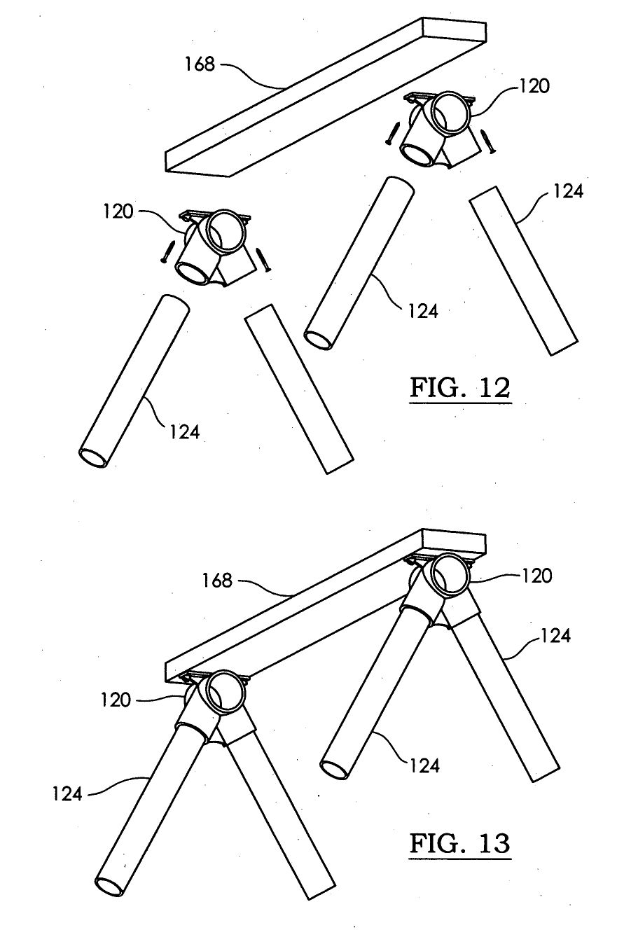

A platform 152 extends transversely outward from atop the longitudinal socket 126 on either side of the longitudinal vertical plane. The platform 152 extends between opposite first 154 and second 156 ends. The platform 152 has an upper surface 158 and a lower surface 160. The platform 152 has a first 162 and a second 164 aperture extending through from the upper surface 158 to the lower surface 160 at the first 154 and second 156 ends respectively. The first 162 and second 164 apertures each typically comprise a boss 166 extending downward from the platform lower surface 160 adjacent the platform first 154 and second 156 end respectively. Each boss 166 includes a hole 167 through it generally parallel with the first 138 and second 140 leg sockets respectively. Each hole 167 has a countersink 169 and is adapted to receive a threaded fastener, typically a flat head wood screw 170. The platform 152 serves to support an optional flat beam 168, as shown in FIGS. 12 and 13. The flat beam 168 is typically a construction grade 2×4 or 2×6 and is fastened through the slot 66 with the wood screws 170. The flat beam 168 provides a conventional style sawhorse for cutting directly upon.

The roller support bracket 120 is molded from a polymeric resin selected from the group consisting of thermoset resins and thermoplastic resins. The preferred material is PVC resin, to match the tubular roller 122 and tubular legs 124. However, any structural grade resin will serve, such as nylon or ABS.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

### PARTS LIST ROLLER SUPPORT BRACKET FOR SAWHORSE

| PART | |
|---|---|
| NO. | DESCRIPTION |
| 20 | roller support bracket |
| 22 | longitudinal tubular roller |
| 24 | tubular legs |
| 26 | longitudinal socket |
| 28 | longitudinal socket first end |
| 30 | longitudinal socket second end |
| 32 | longitudinal socket bore |
| 34 | longitudinal socket outer surface |
| 36 | longitudinal socket inner surface |
| 38 | first leg socket |
| 40 | second leg socket |
| 42 | leg socket proximal end |
| 44 | leg socket distal end |
| 46 | leg socket bore |
| 48 | leg socket outer surface |
| 50 | leg socket inner surface |
| 52 | platform |
| 54 | platform first end |
| 56 | platform second end |
| 58 | platform upper surface |
| 60 | platform lower surface |
| 62 | platform first aperture |
| 64 | platform second aperture |
| 66 | platform slot |
| 68 | flat beam |
| 70 | bolts |
| 72 | nuts |
| 120 | roller support bracket |
| 122 | longitudinal tubular roller |
| 124 | tubular legs |
| 126 | longitudinal socket |
| 128 | longitudinal socket first end |
| 130 | longitudinal socket second end |
| 132 | longitudinal socket bore |
| 134 | longitudinal socket outer surface |
| 136 | longitudinal socket inner surface |
| 138 | first leg socket |
| 140 | second leg socket |
| 142 | leg socket proximal end |
| 144 | leg socket distal end |
| 146 | leg socket bore |
| 147 | shoulder |
| 148 | leg socket outer surface |
| 150 | leg socket inner surface |
| 152 | platform |
| 154 | platform first end |
| 156 | platform second end |
| 158 | platform upper surface |
| 160 | platform lower surface |
| 162 | platform first aperture |
| 164 | platform second aperture |
| 166 | platform boss |
| 167 | platform hole |
| 168 | flat beam |
| 169 | countersink |
| 170 | wood screw |

The embodiments of the invention in which an exclusive property or privilege is claimed are defined as follows:

1. A roller support bracket for a sawhorse, for use in connection with a longitudinal tubular roller and a plurality of upright tubular legs, the roller support bracket comprising:
a longitudinal socket extending along a longitudinal axis between opposite first and second ends, the longitudinal socket having a bore therethrough extending along the longitudinal axis, the longitudinal socket having an outer surface and an inner surface, the longitudinal socket being adapted to slidingly receive the roller; and
first and second leg sockets, extending downward and transversely outward from a proximal end at the longitudinal socket outer surface to a distal end, the first and second leg sockets being on opposite sides of a longitudinal vertical plane, the first and second leg sockets each having a blind bore extending from the distal end toward the proximal end, the first and second leg sockets each having an outer surface and an inner surface, the first and second leg sockets being adapted to slidingly receive the legs.

2. The roller support bracket of claim 1, wherein projections of the bores of the first and second leg sockets pass through the longitudinal socket bore.

3. The roller support bracket of claim 1, wherein the roller support bracket is molded from a polymeric resin selected from the group consisting of thermoset resins and thermoplastic resins.

4. The roller support bracket of claim 1, further comprising a platform extending transversely outward from atop the longitudinal socket on either side of the longitudinal vertical plane, the platform extending between opposite first and second ends, the platform having an upper surface and a lower surface.

5. The roller support bracket of claim 4, wherein the platform further comprises a first and a second aperture extending through from the upper surface to the lower surface at the first and second ends respectively.

6. The roller support bracket of claim 5, wherein the first and a second aperture each further comprises a slot extending transversely inward from the platform first and second end respectively.

7. The roller support bracket of claim 5, wherein the first and a second aperture each further comprises a boss extending downward from the platform lower surface adjacent the platform first and second end respectively, each boss including a hole therethrough generally parallel with the first and second leg sockets respectively, each hole being adapted to receive a threaded fastener.

8. A roller support bracket for a sawhorse, for use in connection with a longitudinal circular cylindrical tubular roller and a plurality of upright circular cylindrical tubular legs, the roller support bracket comprising:
a longitudinal socket extending along a longitudinal axis between opposite first and second ends, the longitudinal socket being a cylinder of circular cross section, the longitudinal socket having a bore therethrough extending along the longitudinal axis, the longitudinal socket having an outer surface and an inner surface, the longitudinal socket being adapted to slidingly receive the roller;
first and second leg sockets, extending downward and transversely outward from a proximal end at the longitudinal socket outer surface to a distal end, the first and second leg sockets being on opposite sides of a longitudinal vertical plane, the first and second leg sockets being cylinders of circular cross section, the first and second leg sockets each having a blind bore extending from the distal end toward the proximal end, the first and second leg sockets each having an outer surface and an inner surface, the first and second leg sockets being adapted to slidingly receive the legs; and
a platform extending transversely outward from atop the longitudinal socket on either side of the longitudinal vertical plane, the platform extending between opposite first and second ends, the platform having an upper surface and a lower surface, the platform having a first and a second aperture extending through from the upper surface to the lower surface at the first and second ends respectively.

9. The roller support bracket of claim 8, wherein projections of the bores of the first and second leg sockets pass through the longitudinal socket bore.

10. The roller support bracket of claim 8, wherein the roller support bracket is molded from a polymeric resin selected from the group consisting of thermoset resins and thermoplastic resins.

11. The roller support bracket of claim 8, wherein the first and a second aperture each further comprises a slot extending transversely inward from the platform first and second end respectively.

12. The roller support bracket of claim 8, wherein the first and a second aperture each further comprises a boss extending downward from the platform lower surface adjacent the platform first and second end respectively, each boss including a hole therethrough generally parallel with the first and second leg sockets respectively, each hole being adapted to receive a threaded fastener.

13. A roller support bracket for a sawhorse, for use in connection with a longitudinal circular cylindrical tubular roller and a plurality of upright circular cylindrical tubular legs, the roller support bracket comprising:
a longitudinal socket extending along a longitudinal axis between opposite first and second ends, the longitudinal socket being a cylinder of circular cross section, the longitudinal socket having a bore therethrough extending along the longitudinal axis, the longitudinal socket having an outer surface and an inner surface, the longitudinal socket being adapted to slidingly receive the roller;
first and second leg sockets, extending downward and transversely outward from a proximal end at the longitudinal socket outer surface to a distal end, the first and second leg sockets being on opposite sides of a longitudinal vertical plane, the first and second leg sockets being cylinders of circular cross section, the first and second leg sockets each having a blind bore extending from the distal end toward the proximal end, projections of the bores of the first and second leg sockets passing through the longitudinal socket bore, the first and second leg sockets each having an outer surface and an inner surface, the first and second leg sockets being adapted to slidingly receive the legs; and
a platform extending transversely outward from atop the longitudinal socket on either side of the longitudinal vertical plane, the platform extending between opposite first and second ends, the platform having an upper surface and a lower surface, the platform having a first and a second aperture extending through from the upper surface to the lower surface at the first and second ends respectively.

14. The roller support bracket of claim 13, wherein the roller support bracket is molded from a polymeric resin selected from the group consisting of thermoset resins and thermoplastic resins.

15. The roller support bracket of claim 13, wherein the first and a second aperture each further comprises a slot extending transversely inward from the platform first and second end respectively.

16. The roller support bracket of claim 13, wherein the first and a second aperture each further comprises a boss extending downward from the platform lower surface adjacent the platform first and second end respectively, each boss including a hole therethrough generally parallel with the first and second leg sockets respectively, each hole being adapted to receive a threaded fastener.

17. The roller support bracket of claim 13, wherein the bores of the first and second leg sockets further comprise shoulders adjacent the proximal ends so as to provide bearing for the legs.
